(19) United States
(12) Patent Application Publication
(10) Pub. No.: US 2026/0365405 A1
(43) Pub. Date: Nov. 19, 2026

(54) WRAP FOR PRODUCT, PACKAGE, AND WRAPPED TIMBER PRODUCT

(71) Applicant: AMCOR FLEXIBLES NORTH AMERICA, INC., NEENAH, WI (US)

(72) Inventor: Phillip VAN HOUTS, Auckland (NZ)

(21) Appl. No.: 19/133,663

(22) PCT Filed: Dec. 6, 2022
(86) PCT No.: PCT/US2022/051977

§ 371 Date: May 28, 2025

(51) Int. Cl. B65D 81/03; B32B 7/05; B32B 27/32; B65D 65/40

(52) U.S. Cl. CPC B65D 81/03; B32B 7/05; B32B 27/32; B65D 65/40; B32B 2255/10; B32B 2307/54

(57) ABSTRACT

A wrap for a product is disclosed. The wrap includes a first film. The wrap further includes a tubular second film. The tubular second film includes a first portion at least partially attached to the first film. The tubular second film further includes a second portion extending from the first portion opposite to the first film. The second portion is detached from the first film. The first portion and the second portion of the tubular second film are configured to at least partially receive the product therebetween. A package and a wrapped timber product are also disclosed.

### TECHNICAL FIELD

The present application relates generally to a wrap for a product, a package, and a wrapped timber product.

### BACKGROUND

Certain products, such as timber products, may be wrapped and covered during transportation and/or storage to protect them from exposure to elements, such as moisture. For example, a stack of timber may be partially wrapped by a wrap.

During shipment and transportation of the products, the wrap may be subjected to a high level of abrasion and abuse. As a result, cuts, holes, and apertures may form on conventional wraps during shipment, which may compromise protection of the products from the elements. Therefore, there is a need for a wrap that maintains its integrity during shipment and/or storage of the products.

### SUMMARY

A wrap for a product has been developed which includes a first film and a second film. The second film includes a first portion at least partially attached to the first film and a second portion extending from the first portion.

The first film and the first portion of the second film may be positioned across a top surface of the product, which may experience a high level of abrasion and abuse. The first film and the first portion of the second film may together improve abrasion resistance, puncture resistance, and impact resistance of the wrap at the top surface of the product. The wrap may therefore maintain its integrity during shipment and/or storage of the product.

One embodiment of the present disclosure is a wrap for a product. The wrap includes a first film. The wrap further includes a tubular second film. The tubular second film includes a first portion at least partially attached to the first film. The tubular second film further includes a second portion extending from the first portion opposite to the first film. The second portion is detached from the first film. The first portion and the second portion of the tubular second film are configured to at least partially receive the product therebetween.

During use, the second portion of the tubular second film may be split into two segments along the direction of a longitudinal axis of the tubular second film. Subsequently, the first portion of the tubular second film may be positioned across a top surface of the product, such that the first film and the first portion of the second film cover at least the top surface of the product, and the two segments at least partially cover respective side surfaces of the product.

The first film and the first portion of the tubular second film may together cover the entire top surface of the product. The first film and the first portion of the second film may together improve abrasion resistance, puncture resistance, and impact resistance of the wrap at least at the top surface of the product. In some examples, the first film and the first portion of the tubular second film may together further cover the top edges of the product. Therefore, during transportation and shipping, the wrap may maintain its integrity at the top surface of the product, which may experience a high level of abrasion and abuse.

In some embodiments, the second portion includes a first segment and a second segment partially or fully disconnected from the first segment. For example, the second portion may include a continuous slit that fully disconnects the second segment from the first segment. Alternatively, the second portion may include a series of non-continuous scores, perforations, cuts, apertures, slits, etc., that partially disconnects the second segment from the first segment.

In some embodiments, the tubular second film extends along a longitudinal axis. The second portion further includes a line of weakness at least partially extending along the direction of the longitudinal axis. The line of weakness may facilitate splitting the second portion of the tubular second film into two segments.

In some embodiments, the first film includes a first transverse width. The tubular second film includes a second transverse width. The second transverse width of the tubular second film may be defined in its flat configuration. The first transverse width is in the range of 80% and 120% of the second transverse width.

In some embodiments, the wrap further includes an adhesive layer that laminates the first portion of the tubular second film to the first film.

In some embodiments, the first portion of the tubular second film is attached to the first film by thermal lamination.

In some embodiments, the first portion of the tubular second film is attached to the first film by spot lamination.

In some embodiments, the wrap includes at least 90% polyethylene, by weight. The wrap may therefore be recyclable in a polyethylene recycling stream.

In some embodiments, the first film and the first portion of the tubular second film together include a tensile strength between 160 Newton per 25 millimeters (N/25 mm) and 190 N/25 mm in a transverse direction as measured according to ASTM D882-12.

Another embodiment of the present disclosure is a package. The package includes a timber product. The package further includes a wrap. The wrap includes a first film. The wrap further includes a second film. The second film includes a first portion at least partially attached to the first film. The second film further includes a second portion extending from the first portion opposite to the first film. The first portion and the second portion of the second film at least partially receive the timber product therebetween.

The first portion of the second film may be positioned across a top surface of the timber product, such that the first film and the first portion of the second film cover at least the top surface of the timber product, and the second portion of the second film at least partially covers each of two side surfaces of the timber product. The first film and the first portion of the second film may together cover the entire top surface of the timber product. In some examples, the first film and the first portion of the second film may together further cover the top edges of the product. The first film and the first portion of the second film may together improve abrasion resistance, puncture resistance, and impact resistance of the wrap at least at the top surface of the timber product. Therefore, during transportation and shipping, the wrap may maintain its integrity at the top surface of the timber product, which may experience a high level of abrasion and abuse.

In some embodiments, each of the first film and the first portion of the second film is continuous and free of any through-apertures.

In some embodiments, the package further includes a printed pigment layer disposed on the second portion of the second film.

Another embodiment of the present disclosure is a wrapped timber product. The wrapped timber product includes a wrap including a first film and a second film. The first film is attached to and extends over a first portion of the second film and a second portion of the second film extends from the first portion. The first portion and the second portion of the second film encompass the timber product.

The first portion of the second film may be positioned across a top surface of the timber product, such that the first film and the first portion cover at least the top surface of the product, and the second portion of the second film at least partially covers each of two side surfaces of the timber product. The first film and the first portion of the second film may together cover the entire top surface of the timber product. In some examples, the first film and the first portion of the second film may together further cover the top edges of the product. The first film and the first portion of the second film may together improve abrasion resistance, puncture resistance, and impact resistance of the wrap at least at the top surface of the timber product. Therefore, during transportation and shipping, the wrap may maintain its integrity at the top surface of the timber product, which may experience a high level of abrasion and abuse.

In some embodiments, the timber product is stacked to a cuboidal shape and the wrap covers five of the six faces of the cuboidal shape. In some examples, the wrap may not cover a bottom face of the six faces of the cuboidal shape.

In some embodiments, the first film and the first portion of the second film are positioned across the top face of the timber product.

In some embodiments, the first film is positioned to cover the entire top face of the timber product and a portion of two or more of the side faces of the timber product.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1A is a schematic cross-sectional view of a wrap in accordance with an embodiment of the present disclosure;

FIG. 1B is a schematic cross-sectional view of the wrap with a second film thereof in a flat configuration in accordance with an embodiment of the present disclosure;

FIG. 2 is a schematic plan view of the wrap with the second film in the flat configuration of FIG. 1B in accordance with an embodiment of the present disclosure;

FIG. 3 is a schematic cross-sectional view of a wrap in accordance with another embodiment of the present disclosure;

FIG. 4A is a schematic cross-sectional view of a package taken along a transverse direction in accordance with an embodiment of the present disclosure;

FIG. 4B is a schematic side view of the package in accordance with an embodiment of the present disclosure; and

FIG. 5 is a schematic perspective view of a wrapped timber product in accordance with an embodiment of the present disclosure.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

The present application describes a wrap for a product. The wrap includes a first film. The wrap further includes a tubular second film. The tubular second film includes a first portion at least partially attached to the first film. The tubular second film further includes a second portion extending from the first portion opposite to the first film. The second portion is detached from the first film. The first portion and the second portion of the tubular second film are configured to at least partially receive the product therebetween.

During use, the second portion of the tubular second film may be split into two segments along the direction of a longitudinal axis of the tubular second film. Subsequently, the first portion of the tubular second film may be positioned across a top surface of the product, such that the first film and the first portion of the second film cover at least the top surface of the product, and the two segments of the second portion of the second film at least partially cover respective side surfaces of the product.

The first film and the first portion of the tubular second film may together cover the entire top surface of the product. In some examples, the first film and the first portion of the tubular second film may together further cover the top edges of the product. The first film and the first portion of the second film may together improve abrasion resistance, puncture resistance, and impact resistance of the wrap at least at the top surface of the product. Therefore, during transportation and shipping, the wrap may maintain its integrity at the top surface of the product, which may experience a high level of abrasion and abuse.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B.”

As used herein, the term “layer” refers to a discrete film or a sheet component. In referring to a monolayer film, “film,” “sheet,” and “layer” are synonymous. Layers may be of any type of material including polymeric, cellulosic, and metallic, or a blend thereof. A given polymeric layer may consist of a single polymer-type or a blend of polymers and may be accompanied by additives.

As used herein, the term “film” is a material with a very high ratio of a length or a width to a thickness. A film has two major surfaces defined by a length and a width. Films typically have good flexibility and can be used for a wide variety of applications. Films may be described as monolayer or multilayer.

As used herein, the term “tubular film” refers to a film having a longitudinal axis around which the film extends. A tubular film may be straw-like or tube-like. A tubular film may be produced by (co) extrusion, preferably by blown film (co) extrusion. A tubular film may have no sealed seam or may have one or more sealed seams in the longitudinal direction.

As used herein, the term “line of weakness” refers to a continuous or non-continuous series of holes, vents, slits, slots, perforations, notches, punctures, orifices, openings, inlets, channels, etc., in the surface of or through a film or a layer. Line of weakness may also be referred to as “score line”. A line of weakness may have varying depths. Its depth may extend from the first surface of a layer to the second surface of the layer (i.e., throughout the entire thickness of the layer). Alternatively, its depth may extend from about 50% to about 95% of the thickness of a layer. A line of weakness may be formed by mechanical means (e.g., using a cutting blade), by chemical means (e.g., using solvents), by thermal means (e.g., by optical ablation), or by other means known in the art.

As used herein, the term “adhesive layer” refers to a layer which has a primary function of bonding two adjacent films together. Adhesive layers may be positioned between two films to maintain the two films in position relative to each other and prevent undesirable delamination. Unless otherwise indicated, an adhesive layer can have any suitable composition that provides a desired level of adhesion with the one or more surfaces in contact with the adhesive layer material. Adhesive layers may be substantially continuous or patterned.

As used herein, the term “wrap” refers to any article or combination of articles used to wholly or partially surround a product. As used herein, the term “package” refers to a product wholly or partially surrounded by a wrap. A wrap or package may take various forms. For example, the term “wrap” may include bags that wholly surround a product (or products) to be packaged. The term “wrap” may also include films that partially surround a product (or products) to be packaged. The term “wrap” may also include multiple films or other articles, that when used in conjunction with each other, wholly or partially surround a product (or products).

As used herein, the term “polymeric” refers to a material which is the product of a polymerization reaction of natural, synthetic, or natural and synthetic ingredients, and is inclusive of homopolymers, copolymers, terpolymers, etc. In general, the layers of a film or substrate may comprise a single polymer, a mixture of a single polymer and non-polymeric materials, a combination of two or more polymeric materials blended together, or a mixture of a blend of two or more polymeric materials and non-polymeric materials.

As used herein, the term “polyethylene” or “PE” refers to, unless indicated otherwise, ethylene homopolymers or copolymers. The term “polyethylene” or “PE” is used without regard to the presence or absence of substituent branch groups. Polyethylene includes, for example, medium density polyethylene, high density polyethylene, low density polyethylene, linear low-density polyethylene, ultra-low density polyethylene, ethylene alpha-olefin copolymer, or blends of such.

As used herein, the term “extrusion” refers to the process of forming continuous shapes by forcing a molten plastic material through a die, followed by cooling or chemical hardening. The term “coextruded” refers to the process of extruding two or more materials through a single die with two or more orifices arranged so that the extrudates merge and weld together into a laminar structure before chilling (i.e., quenching).

As used herein, the term “blown film extrusion” refers to a process in which a polymer melt is extruded through a circular die followed by bubble-like expansion.

As used herein, the term “printed pigment layer” refers to printed layer of a marking, image, text, and/or symbol located on the surface of a film, sheet, or web. The printed pigment layer can be placed on a surface by any suitable means (e.g., rotogravure or flexographic printing, digital printing, laser printing, etc.). The printed pigment layer can include, e.g., a printed message or instructions, product description or branding, weight of product, manufacturer name and address, manufacturer trademark, etc.

As herein, the term “machine direction” or “MD” refers to the direction of film transport during or after extrusion or film conversion. The term “transverse direction” or “TD” refers to the direction perpendicular to the machine direction.

As used herein, the term “adhesive lamination” refers to a process in which two or more films, layers, or sheets are joined together using an adhesive. The adhesive is applied to one film, layer or sheet and is then contacted to another film, layer, or sheet. Depending on the type of adhesive used, the adhesive may be dried or cured either before or after connecting to the second film, layer, or sheet.

As used herein, the terms “heat lamination” and “thermal lamination” refer to a process in which two or more layers are bonded to each other by the application of heat and pressure, such that the two or more layers remain adhered to each other when the pressure is removed. Heat or thermal lamination may or may not require an adhesive material.

As used herein, the term “spot lamination” refers to a process in which two or more layers are bonded to each other at a plurality of spots, areas, or regions with unbonded regions therebetween. In other words, the bonding occurs in a pattern and is not coextensive with the layers.

As used herein, the term “timber” refers to all types of species of wood, and all types of working of this wood, for example, solid wood, high-density wood, laminated wood, and plywood.

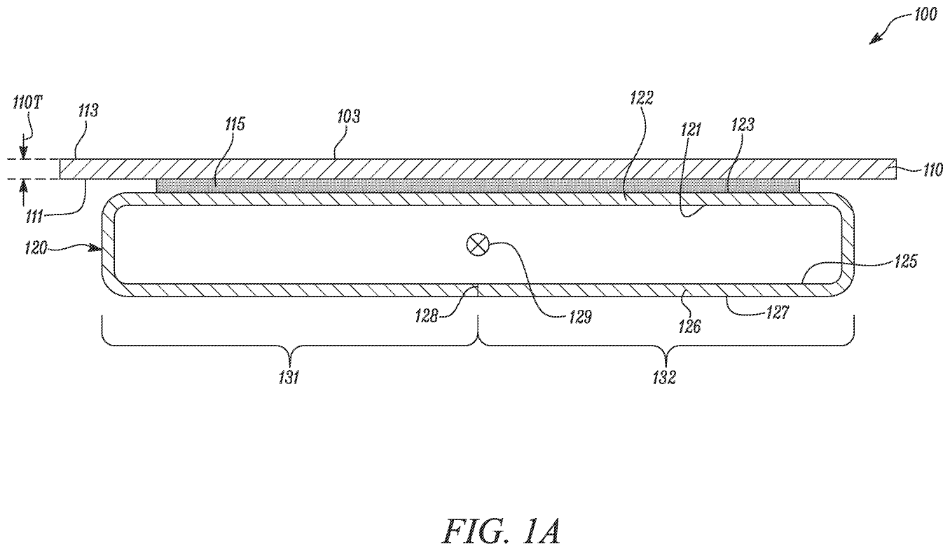

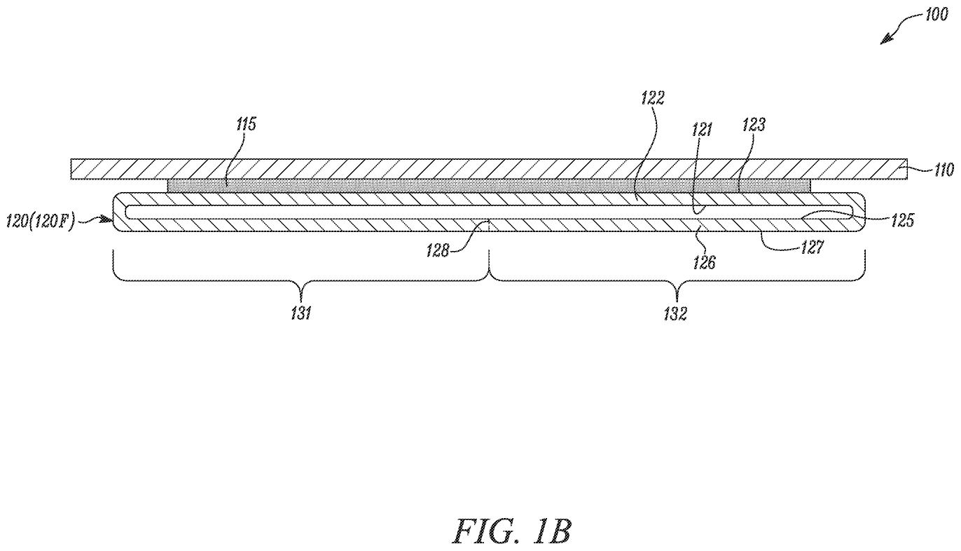

FIG. 1A shows a schematic cross-sectional view of a wrap 100 for a product in accordance with an embodiment of the present disclosure.

Wrap 100 includes a first film 110. First film 110 may include an inner surface 111 and an outer surface 113 opposite to inner surface 111. First film 110 may further include a thickness 110T defined between inner surface 111 and outer surface 113. Thickness 110T may range from, for example, 50 microns to 200 microns. Furthermore, outer surface 113 of first film 110 may form an outer surface 103 of wrap 100.

First film 110 may be a polymeric film. In some embodiments, first film 110 may include at least 80% polyethylene, by weight. In some embodiments, first film 110 may include at least 90% polyethylene, by weight. In some embodiments, first film 110 may include 100% polyethylene, by weight.

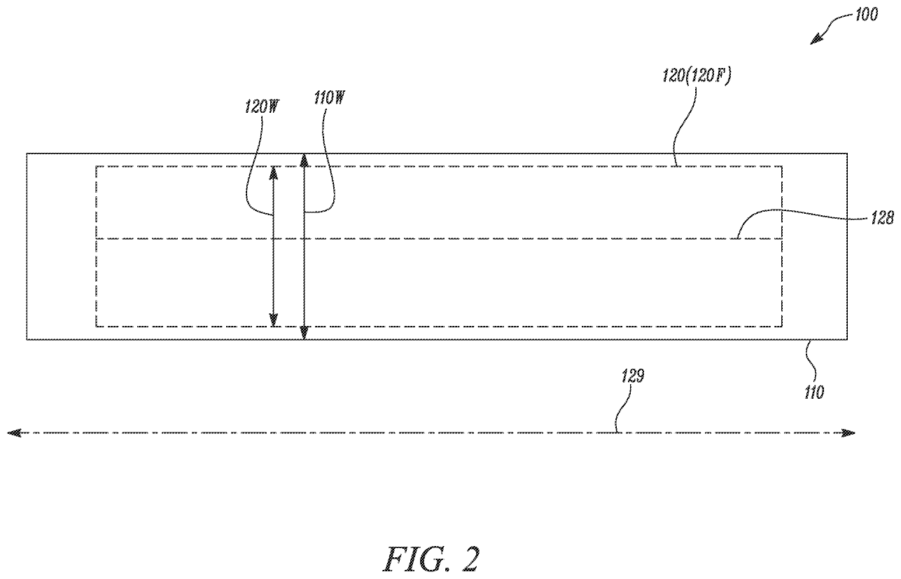

Wrap 100 further includes a second film 120. In the illustrated embodiment of FIG. 1A, second film 120 is a tubular film. That is, in the illustrated embodiment of FIG. 1A, second film 120 has a longitudinal axis 129 (also shown in FIG. 2) around which it extends. Therefore, second film 120 may have a straw-like or tube-like structure. In such embodiments, second film 120 may be interchangeably referred to as “tubular second film 120.” Tubular second film 120 may be produced by any suitable method, such as blown film extrusion. Tubular second film 120 may include at least 80% polyethylene, by weight. Tubular second film 120 may include at least 90% polyethylene, by weight. Tubular second film 120 may include 100% polyethylene, by weight.

Tubular second film 120 includes a first portion 122. First portion 122 is at least partially attached to first film 110. First portion 122 may be at least partially attached to first film 110 by any suitable method. As shown in FIG. 1A, in some embodiments, wrap 100 may further include an adhesive layer 115 that laminates first portion 122 of tubular second film 120 to first film 110. Adhesive layer 115 may be at least partially disposed between first film 110 and first portion 122 of second film 120. Adhesive layer 115 may be substantially continuous or patterned. Adhesive layer 115 may include any suitable adhesive, for example, water-soluble adhesives, radiation curable or heat-curable adhesives, hot melt adhesives, pressure sensitive adhesives, and the like. In some embodiments, first portion 122 of tubular second film 120 may be attached to first film 110 by thermal lamination, thus no adhesive layer 115 is present. In some embodiments, first portion 122 of tubular second film 120 may be attached to first film 110 by spot lamination (i.e., patterned).

First portion 122 may include a first inner surface 121 and a first outer surface 123 opposite to first inner surface 121. First outer surface 123 may face first film 110. Specifically, first outer surface 123 may face, and be connected to, inner surface 111 of first film 110.

Tubular second film 120 further includes a second portion 126. Second portion 126 extends from first portion 122. Second portion 126 may extend from first portion 122 opposite to first film 110. Second portion 126 may extend over first portion 122 of second film 120. First portion 122 and second portion 126 may be defined as opposite sides of flattened tubular second film 120. Alternatively, first portion 122 may be defined as the portion connected to first film 110 and second portion 122 may be defined as the portion not connected to first film 110.

First portion 122 and second portion 126 of tubular second film 120 may be integral with each other. Further, second portion 126 may be detached from first film 110. In other words, second portion 126 may not be connected to first film 110. Second portion 126 may include a second inner surface 125 and a second outer surface 127 opposite to second inner surface 125.

Tubular second film 120 may be collapsible on itself into a flat configuration 120F, as shown in FIG. 1B. FIG. 1B shows a schematic cross-sectional view of wrap 100 with tubular second film 120 in flat configuration 120F in accordance with an embodiment of the present disclosure.

As shown in FIG. 1B, in flat configuration 120F, first inner surface 121 of first portion 122 may be near or touch second inner surface 125 of second portion 126. Further, in flat configuration 120F, second outer surface 127 of second portion 126 may face opposite to first outer surface of 121 of first portion 122.

FIG. 2 shows a schematic plan view of wrap 100 in accordance with an embodiment of the present disclosure. In FIG. 2, tubular second film 120 is in flat configuration 120F.

Referring to FIG. 2, first film 110 may include a first transverse width 110W. First transverse width 110W may be defined perpendicular to longitudinal axis 129. Further, tubular second film 120 may include a second transverse width 120W. Second transverse width 120W may be defined perpendicular to the direction of longitudinal axis 129 in flat configuration 120F of second film 120.

In some embodiments, first transverse width 110W may be in the range of 80% and 120% of second transverse width 120W. In some embodiments, first transverse width 110W may be in the range of 85% to 115% of second transverse width 120W. In some embodiments, first transverse width 110W may be in the range of 90% to 110% of second transverse width 120W.

Referring to FIGS. 1A and 1B, second portion 126 may include a first segment 131 and a second segment 132 partially or fully disconnected from first segment 131. As discussed above, tubular second film 120 may extend along longitudinal axis 129. In some embodiments, first segment 131 and second segment 132 may be fully disconnected from each other by a slit extending along the direction of longitudinal axis 129. In some embodiments, second portion 126 may further include a line of weakness 128 at least partially extending along the direction of longitudinal axis 129. Line of weakness 128 may include a continuous or non-continuous series of holes, vents, slits, slots, perforations, notches, punctures, orifices, openings, inlets, channels, etc.

First portion 122 and second portion 126 of tubular second film 120 are configured to at least partially receive the product therebetween. In other words, first portion 122 and second portion 126 may encompass the product. The product may include, for example, a timber product, such as a stack of timber.

During use, second portion 126 of tubular second film 120 may be split into two segments (e.g., first and second segments 131, 132) along the direction of longitudinal axis 129. In some examples, line of weakness 128 may facilitate splitting of second portion 126 into the two segments. Subsequently, first portion 122 of tubular second film 120 may be positioned across a top surface of the product, such that first film 110 and first portion 122 of second film 120 cover at least the top surface of the product, and the two segments 131,132 at least partially cover respective side surfaces of the product. In some cases, first film 110 may further cover the top edges of the product.

First film 110 and first portion 122 may together improve abrasion resistance, puncture resistance, and impact resistance of wrap 100 at least at the top surface of the product. In some embodiments, first film 110 and first portion 122 of tubular second film 120 may together include a tensile strength between 160 Newtons per 25 millimeters (N/25 mm) and 190 N/25 mm in a transverse direction as measured according to ASTM D882-12. In some embodiments, the tensile strength in the transverse direction may range between 170 N/25 mm and 180 N/25 mm. In some embodiments, first film 110 and first portion 122 of tubular second film 120 may together include an impact resistance between 1050 gram and 2010 gram as measured according to ASTM D 1709-03. In some embodiments, first film 110 and first portion 122 of tubular second film 120 may together include a puncture resistance between 50 Newton and 65 Newton as measured according to ASTM F1342-05. Therefore, during transportation and shipping, wrap 100 may maintain its integrity at the top surface of the product, which may experience a high level of abrasion and abuse.

Wrap 100 may be rolled into a rolled configuration and provided for use in the rolled configuration. During use, wrap 100 may be conveniently unrolled from the rolled configuration and cut to desired longitudinal direction dimensions based on dimensions of the product.

In some embodiments, wrap 100 may include at least 90% polyethylene, by weight. In some embodiments, wrap 100 may include at least 95% polyethylene, by weight. In some embodiments, wrap 100 may include 100% polyethylene, by weight. In such embodiments, wrap 100 may be recyclable. Wrap 100 may be suitable for recycling in a polyethylene recycling stream.

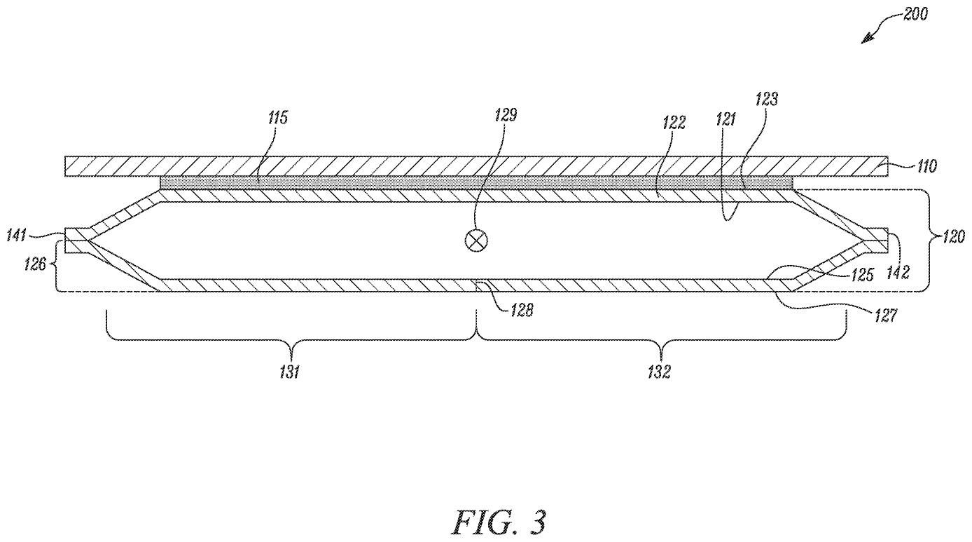

FIG. 3 shows a schematic cross-sectional view of a wrap 200 in accordance with another embodiment of the present disclosure. Wrap 200 is similar to wrap 100 of FIGS. 1A-2, with like elements designated by like reference characters. However, wrap 200 has a different configuration of second film 120 than that of tubular second film 120 of wrap 100.

Specifically, in the illustrated embodiment of FIG. 3, second portion 126 is a different film than first portion 122. In other words, in the illustrated embodiment of FIG. 3, second portion 126 is integral with first portion 122 by way of bonding first portion 122 to second portion 126. For example, first portion 122 may be formed by a first film component, and second portion 126 may be formed by a second film component separate from the first film component. The first film component may be similar to or different from the second film component.

As shown in FIG. 3, first portion 122 may include a pair of longitudinal edges 141, 142. Second portion 126 may only be connected to first portion 122 at pair of longitudinal edges 141, 142. Therefore, a major portion of first inner surface 121 of first portion 122 may be disconnected from second inner surface 125 of second portion 126. Second portion 126 may be connected to first portion 122 at pair of longitudinal edges 141, 142 by any suitable method, such as adhesive lamination, heat lamination, and the like. Wrap 200 may be used similarly to wrap 100, as described above.

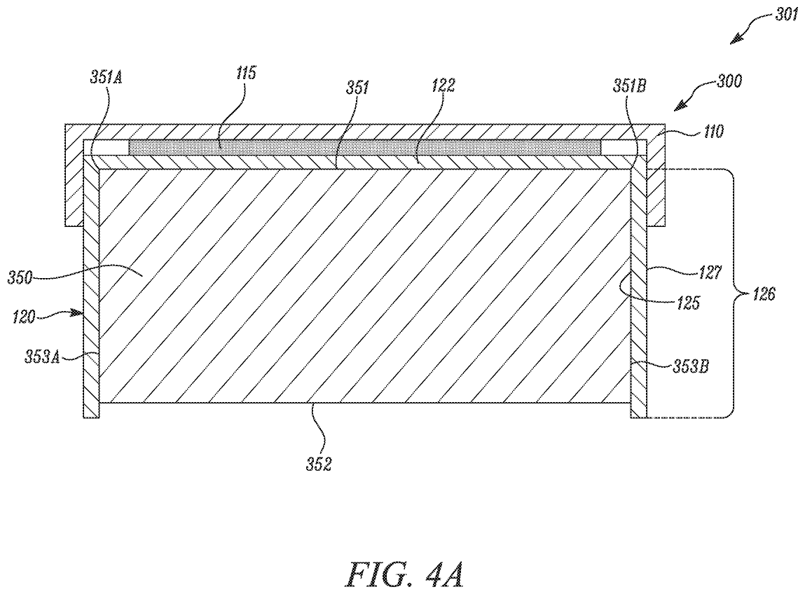

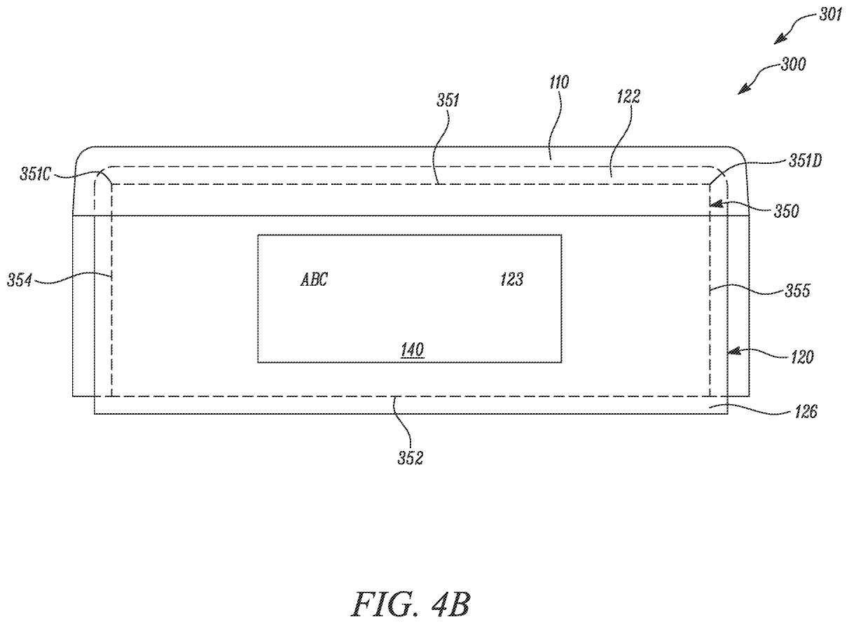

FIG. 4A shows a schematic cross-sectional view of a package 301 in accordance with an embodiment of the present disclosure.

Package 301 includes a timber product 350. Timber product 350 may include timber stacked to a cuboidal shape. As a result, timber product 350 may include six surfaces (only four visible in the view of FIG. 4A). Specifically, timber product 350 may include a top surface 351, a bottom surface 352 opposite to top surface 351, and a pair of side surfaces 353A, 353B connected to top surface 351 and bottom surface 352. Timber product 350 may further include a front surface 354 and a rear surface 355 opposite to front surface 354 (shown in FIG. 4B).

Package 301 further includes a wrap 300. Wrap 300 is similar to wrap 100 of FIGS. 1A-2 or wrap 200 of FIG. 3, with like elements designated by like reference characters.

Specifically, wrap 300 includes first film 110. Wrap 300 further includes second film 120 including first portion 122 at least partially attached to first film 110 and second portion 126 extending from the first portion 122 opposite to first film 110. First portion 122 and second portion 126 of second film 120 at least partially receive timber product 350 therebetween. Each of first film 110 and first portion 122 of second film 120 may be continuous and free of any through-apertures.

As shown in FIG. 4A, first portion 122 of second film 120 may be positioned across top surface 351 of timber product 350, such that first film 110 and first portion 122 of second film 120 cover at least top surface 351 of timber product 350, and second portion 126 of second film 120 at least partially covers each of pair of side surfaces 353A, 353B of timber product 350. Wrap 300 may not fully cover bottom surface 352 of timber product 350.

First film 110 and first portion 122 of second film 120 may together improve abrasion resistance, puncture resistance, and impact resistance of wrap 300 at least at top surface 351 of timber product 350. Further, as shown in FIG. 4A, first film 110 may further cover top edges 351A, 351B of timber product 350. First film 110 may further cover top edges 351C, 351D of timber product 350, as shown in FIG. 4B. Top edge 351A is the connection between top surface 351 and side surface 353A. Top edge 351B is the connection between top surface 351 and side surface 353B. Top edge 351C is the connection between top surface 351 and front surface 354. Top edge 351D is the connection between top surface 351 and rear surface 355. Wrap 300 may be fastened to timber product 350 by stapling, strapping, etc.

Package 301 may be suitable for transportation and shipping, as wrap 300 may maintain its integrity at top surface 351 of timber product 350 during transportation and shipping. Top surface 351 of timber product 350 may experience a high level of abrasion and abuse. Package 301 may be suitable for transportation and shipping, as wrap 300 may maintain its integrity at top edges 351A-D of timber product 350 during transportation and shipping. Top edges 351A-D of timber product 350 may experience a high level of abrasion and abuse.

Further, as shown in FIG. 4B, package 301 may further include a printed pigment layer 140 disposed on second portion 126 of second film 120. Specifically, wrap 300 may include printed pigment layer 140 disposed on second portion 126 of second film 120. It may be noted that wrap 100 of FIGS. 1A-2 and wrap 200 of FIG. 3 may also include printed pigment layer 140 disposed on second portion 126 of second film 120.

Printed pigment layer 140 may be formed by any suitable printing process, such as offset printing, flexography, rotogravure, digital printing process, and the like. Printed pigment layer 140 may be located on at least one of second inner surface 125 and second outer surface 127 of second portion 126.

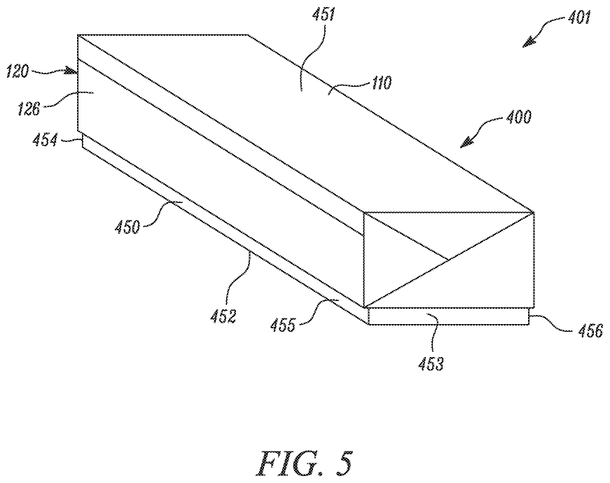

FIG. 5 shows a schematic perspective view of a wrapped timber product 401 in accordance with an embodiment of the present disclosure.

Wrapped timber product 401 includes a wrap 400. Wrap 400 is similar to wrap 100 of FIGS. 1A-2 or wrap 200 of FIG. 3, with like elements designated by like reference characters. Specifically, wrap 400 includes first film 110 and second film 120. First film 110 is attached to and extends over first portion 122 of second film 120 and second portion 126 of second film 120 extends from the first portion 122. First portion 122 and the second portion 126 of second film 120 encompass a timber product 450.

As shown in FIG. 5, timber product 450 may be stacked to a cuboidal shape. The cuboidal shape may include six faces. Therefore, timber product 450 may include faces 451, 452, 453, 454, 455, 456. Face 451 may be a top face, face 452 may be a bottom face, face 453 may be a front face, face 454 may be a rear face, and faces 455, 456 may be side faces of the cuboidal shape.

Further, as shown in FIG. 5, wrap 400 may cover five of the six faces of the cuboidal shape. Specifically, wrap 400 may cover the five faces 451, 453, 454, 455, 456. Wrap 400 may not entirely cover face 452 (i.e., the bottom face of the cuboidal shape).

First film 110 and the first portion 122 of second film 120 may be positioned across the top face 451 of timber product 450. First film 110 may be positioned to cover the entire top face 451 of timber product 450 and a portion of two or more of side faces 453, 454, 455, 456 of timber product 450. A length of wrap 400 may be draped over timber product 450, such that first film 110 also extends down over front and rear faces 453,454 of timber product 450. Subsequently, second portion 126 may be folded in and across front and rear faces 453,454 of timber product 450, as shown in FIG. 5. Wrap 400 may be fastened to timber product 450 by stapling, strapping, etc.

Therefore, wrapped timber product 401 may be suitable for transportation and shipping, as wrap 400 may maintain its integrity at top face 451 of timber product 450 during transportation and shipping. Top face 451 of timber product 450 may experience a high level of abrasion and abuse.

### Experimental Results

An example wrap according to the present disclosure was developed. The example wrap included a polyethylene first film. The example wrap further included a polyethylene tubular second film that was made using blown-film extrusion. A first portion of the tubular second film was attached to the first film by adhesive lamination.

For comparison with the example wrap, a comparison polyethylene wrap was selected. The comparison wrap was a continuous single (i.e., not laminated) polyethylene film. The thickness of the continuous film of the comparison wrap was equivalent to the thickness of each of the first film and the first portion of the tubular second film.

Each of the example wrap and the comparison wrap was used to wrap a cuboidal product. Various tests were performed on each of the example wrap and the comparison wrap to determine the physical properties thereof at a top portion of the cuboidal product.

In the case of the example wrap, the first film and the first portion of the second film were positioned at the top portion of the cuboidal product after wrapping. In the case of the conventional wrap, the continuous polyethylene film was positioned at the top portion of the cuboidal product after wrapping. The results of the performed tests are tabulated in Table 1 provided below.

TABLE 1
Test results

| | | | | Comparison | | Example | | |
|---|---|---|---|---|---|---|---|---|
| | | | | Wrap | | Wrap | | |
| Test | | | Test | Typical | | Typical | | |
| No. | Properties | | Method | Value | Tolerance | Value | Tolerance | SI Unit |
| 01 | Gauge | | Micrometer | 70 | 3 | 140 | 6 | Micron |
| | | | Mitutoyo | | | | | |
| | | | 7301 | | | | | |
| 02 | Tensile | MD | ASTM D | 92 | 1 | 185 | 5 | N/25 mm |
| | Strength | TD | 882-12 | 85 | 6 | 177 | 5 | N/25 mm |
| 03 | Extension | MD | ASTM D | 431 | 12 | 445 | 12 | mm |
| | | TD | 882-12 | 433 | 13 | 476 | 13 | mm |
| 04 | Elongation | MD | ASTM D | 862 | 24 | 890 | 24 | % |
| | | TD | 882-12 | 866 | 26 | 952 | 26 | % |
| 05 | Needle | 1 mm | ASTM | 45 | 2 | 58 | 5 | Newton |
| | Puncture | HS | F1342-05 | | | | | |
| 06 | Dart | 50% | ASTM D | 450 | 10 | 1080 | 20 | Gram |
| | Impact | P/F | 1709-03 | | | | | |
| 07 | Lamination | TD/ | ASTM F | — | — | 12 | 2 | Newton |
| | Bond | MD | 904-98 | | | | | |
| | Strength | | (2003) | | | | | |

As depicted by Table 1, the example wrap had improved tensile strength at the top portion of the cuboidal product in both the machine direction (185 N/25 mm vs 92 N/25 mm) and the transverse direction (177 N/25 mm vs 85 N/25 mm) as compared to the comparison wrap. Further, the example wrap had improved puncture resistance at the top portion of the cuboidal product (58 Newton vs 45 Newton) as compared to the comparison wrap. Moreover, the example wrap had improved impact strength at the top portion of the cuboidal product (1080 Gram vs 450 Gram) as compared to the comparison wrap. In conclusion, the example wrap was found to be excellent in maintaining its integrity during shipping and storage of the cuboidal product.

### Embodiments

Wrap A: A wrap for a product, the wrap comprising:
a first film; and
a tubular second film comprising:
   a first portion at least partially attached to the first film; and
   a second portion extending from the first portion opposite to the first film, wherein the second portion is detached from the first film;
wherein the first portion and the second portion of the tubular second film are configured to at least partially receive the product therebetween.

Wrap B: The wrap of Wrap A, wherein the second portion comprises a first segment and a second segment partially or fully disconnected from the first segment.

Wrap C: The wrap of Wrap A or B, wherein the tubular second film extends along a longitudinal axis, and wherein the second portion further comprises a line of weakness at least partially extending along the direction of the longitudinal axis.

Wrap D: The wrap of any of Wrap A-C, wherein the first film comprises a first transverse width, wherein the tubular second film comprises a second transverse width, and wherein the first transverse width is in the range of 80% and 120% of the second transverse width.

Wrap E: The wrap of any of Wrap A-D, further comprising an adhesive layer that laminates the first portion of the tubular second film to the first film.

Wrap F: The wrap of any of any of Wrap A-E, wherein the first portion of the tubular second film is attached to the first film by thermal lamination.

Wrap G: The wrap of any of Wrap A-F, wherein the first portion of the tubular second film is attached to the first film by spot lamination.

Wrap H: The wrap of any of Wrap A-G, wherein the wrap comprises at least 90% polyethylene, by weight.

Wrap I: The wrap of any of Wrap A-H, wherein the first film and the first portion of the tubular second film together comprise a tensile strength between 160 N/25 mm and 190 N/25 mm in a transverse direction as measured according to ASTM D882-12.

Package A: A package comprising:
a timber product; and
a wrap comprising:
   a first film; and
   a second film comprising:
      a first portion at least partially attached to the first film; and
      a second portion extending from the first portion opposite to the first film;
wherein the first portion and the second portion of the second film at least partially receive the timber product therebetween.

Package B: The package of Package A, wherein each of the first film and the first portion of the second film is continuous and free of any through-apertures.

Package C: The package of Package A or B, further comprising a printed pigment layer disposed on the second portion of the second film.

Wrapped Product A: A wrapped timber product comprising:
a wrap comprising a first film and a second film, the first film attached to and extending over a first portion of the second film and a second portion of the second film extending from the first portion;
wherein the first portion and the second portion of the second film encompass the timber product.

Wrapped Product B: The wrapped timber product of Wrapped Product A, wherein the timber product is stacked to a cuboidal shape and the wrap covers five of the six faces of the cuboidal shape.

Wrapped Product C: The wrapped timber product of Wrapped Product B, wherein the first film and the first portion of the second film are positioned across the top face of the timber product.

Wrapped Product D: The wrapped timber product of Wrapped Product C, wherein the first film is positioned to cover the entire top face of the timber product and a portion of two or more of the side faces of the timber product.

1. A wrap for a product, the wrap comprising:
a first film; and
a tubular second film comprising:
a first portion at least partially attached to the first film; and
a second portion extending from the first portion opposite to the first film, wherein the second portion is detached from the first film;
wherein the first portion and the second portion of the tubular second film are configured to at least partially receive the product therebetween; and
the wrap comprises at least 90% polyethylene, by weight.

2. The wrap according to claim 1, wherein the second portion comprises a first segment and a second segment partially or fully disconnected from the first segment.

3. The wrap according to claim 1, wherein the tubular second film extends along a longitudinal axis, and wherein the second portion further comprises a line of weakness at least partially extending along the direction of the longitudinal axis.

4. The wrap according to claim 1, wherein the first film comprises a first transverse width, wherein the tubular second film comprises a second transverse width, and wherein the first transverse width is in the range of 80% and 120% of the second transverse width.

5. The wrap according to claim 1, further comprising an adhesive layer that laminates the first portion of the tubular second film to the first film.

6. The wrap according to claim 1, wherein the first portion of the tubular second film is attached to the first film by thermal lamination.

7. The wrap according to claim 1, wherein the first portion of the tubular second film is attached to the first film by spot lamination.

8. (canceled)

9. The wrap according to claim 1, wherein the first film and the first portion of the tubular second film together comprise a tensile strength between 160 N/25 mm and 190 N/25 mm in a transverse direction as measured according to ASTM D882-12.

10. A package comprising:
a timber product; and
a wrap comprising:
a first film; and
a second film comprising:
a first portion at least partially attached to the first film; and
a second portion extending from the first portion opposite to the first film;
wherein the first portion and the second portion of the second film at least partially receive the timber product therebetween.

11. The package according to claim 10, wherein each of the first film and the first portion of the second film is continuous and free of any through-apertures.

12. The package according to claim 10, further comprising a printed pigment layer disposed on the second portion of the second film.

13. A wrapped timber product comprising:
a wrap comprising a first film and a second film, the first film attached to and extending over a first portion of the second film and a second portion of the second film extending from the first portion;
wherein the first portion and the second portion of the second film encompass the timber product; and
the timber product is stacked to a cuboidal shape and the wrap covers five of the six faces of the cuboidal shape.

14. (canceled)

15. The wrapped timber product according to claim 14, wherein the first film is positioned to cover the entire top face of the timber product and a portion of two or more of the side faces of the timber product.

16. The wrapped timber product according to claim 15, wherein the first film is positioned to cover the entire top face of the timber product and a portion of two or more of the side faces of the timber product.
